(19) United States
(12) Patent Application Publication
(10) Pub. No.: US 2024/0168571 A1
(43) Pub. Date: May 23, 2024

(54) Systems and Methods for Rendering Characters using a Combination of Keystrokes on a Physical or Virtual Keyboard

(71) Applicant: Aberra Molla, Brighton, CO (US)

(72) Inventor: Aberra Molla, Brighton, CO (US)

(21) Appl. No.: 18/518,262

(22) Filed: Nov. 22, 2023

Related U.S. Application Data
(60) Provisional application No. 63/576,457, filed on Nov. 23, 2022.

(51) Int. Cl. G06F 3/023; G06F 3/04842; G06F 3/04886; G06F 3/16

(52) U.S. Cl. CPC G06F 3/0233; G06F 3/04842; G06F 3/04886; G06F 3/167

(57) ABSTRACT

Systems and methods are disclosed herein that enable rendering various Ethiopic and Latin characters using a combination of keystrokes on a QWERTY keyboard. Example features include an active help feature and rendering glyph options to a virtual screen for a user to touch to select and render a chosen glyph. When the glyph is selected, a sound may be played.

### CROSS-REFERENCE TO RELATED APPLICATIONS

The present application claims the benefit of and priority, under 35 U.S.C. § 119(e), to U.S. Provisional Application Ser. No. 63/576,457, filed on Nov. 23, 2022, entitled “Standard Ethiopic Keyboard,” which is hereby incorporated by reference, in its entirety, for all that it teaches and for all purposes.

The present application is also related to U.S. Patent Application No. 63/294,691; U.S. Pat. Nos. 9,000,957 and 10,133,362; and International Applications PCT/US23/67258 and PCT/IB2023/000614, the entire disclosures of which are hereby incorporated by reference.

### FIELD

The present disclosure is generally directed to keyboards and, in particular, toward typing characters on QWERTY keyboards.

### BACKGROUND

The inventor computerized Ethiopic with two-byte representations distributed on eight ASCII codes in 1983 using modified MegaWriter app along with an Ethiopic keyboard.

### SUMMARY

Deficiencies in the art are addressed by embodiments of the present disclosure. Embodiments of the present disclosure provide an active help feature that helps guide the user through rendering of different glyphs or characters. For instance, the user may enter a first keystroke, and a menu may be rendered that includes a set of keystrokes that can be entered, as well as a set of corresponding characters or glyphs that will be rendered based on the keystroke the user inputs. In some cases, the user may be able to click with their mouse and/or touch the screen with their finger to select the keystroke from the set of keystrokes, and the corresponding character will be rendered. Additionally or alternatively, an audio file may be played. The audio file may be associated with the rendered glyph (e.g., the sound associated with the glyph), which may be beneficial for new users or users learning a new language.

### BRIEF DESCRIPTION OF THE DRAWINGS

FIG. 1 shows an example of signs and symbols that can be typed with number keys according to at least one embodiment of the present disclosure.

FIG. 2 shows a Heleheme Standard keyboard according to at least one embodiment of the present disclosure.

FIG. 3 shows an Amharic Layout according to at least one embodiment of the present disclosure.

FIG. 4 shows an example set of glyphs that can be typed from a key according to at least one embodiment of the present disclosure.

FIG. 5 shows an example layout of a keyboard according to at least one embodiment of the present disclosure.

FIG. 6 shows an Amharic Layout according to at least one embodiment of the present disclosure.

FIG. 7 shows an example set of glyphs that can be typed from a key according to at least one embodiment of the present disclosure.

FIG. 8 shows an example touchscreen interface where a user can click or touch a virtual representation of a symbol to render the symbol according to at least one embodiment of the present disclosure.

FIG. 9 shows an example Ethiopic typeface according to at least one embodiment of the present disclosure.

### DETAILED DESCRIPTION

A significant novelty is assignment of any key for use as Ethiopic vowel. These include the “aeiouv.” keys and their shifted positions, the command keys as well as the number keys and their shifts and the numeric keypad keys. Even the “/*−+.” keys have been made available. For instance, the “tab” key alone when used as a consonant and its depressed position generates more than a hundred glyphs from the 101 keys of the keyboard. Combining the ABSHA with the Molla writing systems give huge combinations.

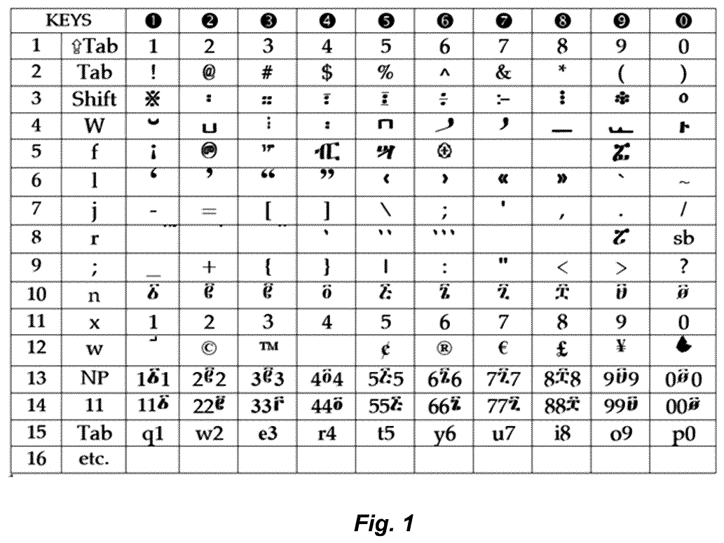

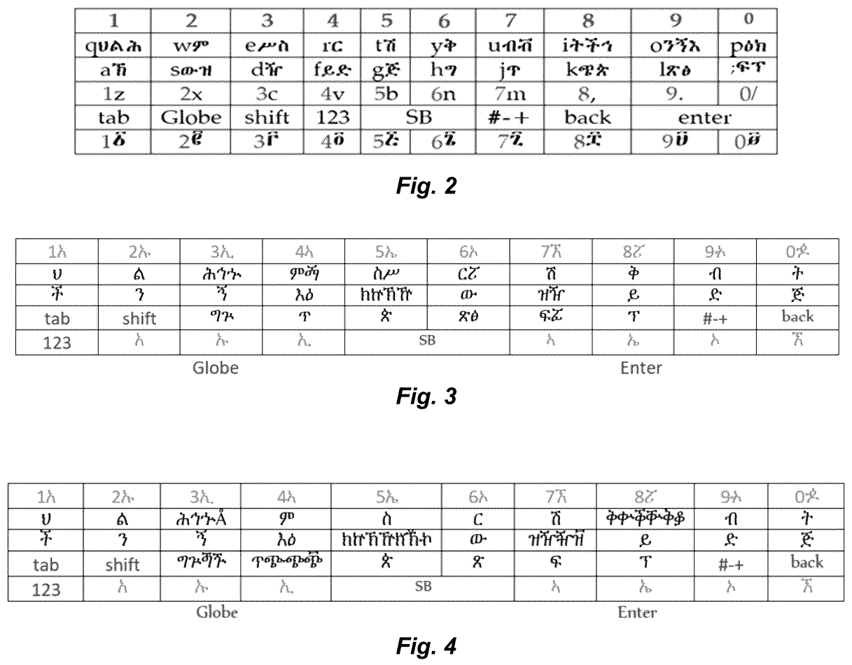

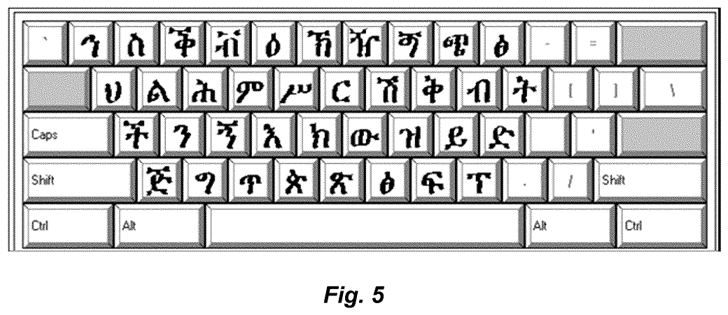

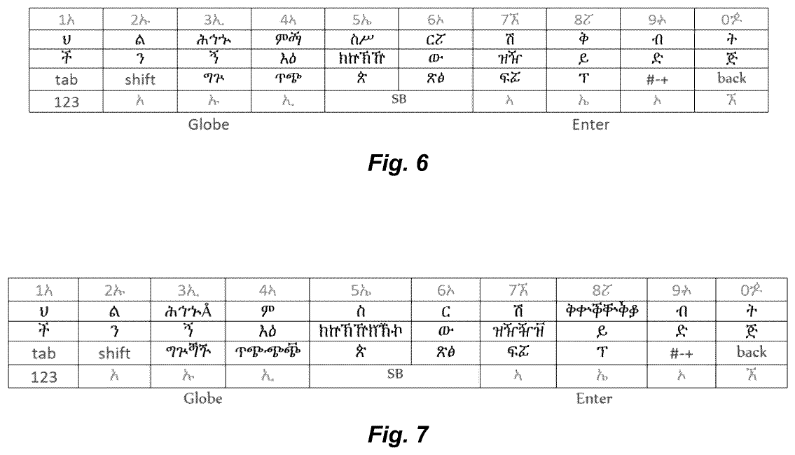

A method of typing the more than 100 Ethiopic and Latin symbols and signs using the ten number keys as vowels is new. In the past some of these have been typed from the number keys of the QWERTY and [symbol] keyboards as in FIG. 48 and as shown in FIGS. 31 and 34 of U.S. Pat. No. 10,133,362. An expanded version of the patented typing where a glyph is settled with a keystroke or its shifted form is expanded to the signs and symbols that include Ethiopic and Latin glyphs. FIG. 1 shows an example of signs and symbols that can be typed with number keys. The first row (row 1) is to show that the numbers are typed with the shifted tab. The Ethiopic period (“ [symbol] ”) can be typed as usual with “ [symbol] tab” and “3” or “shift 3” (“#”). Similarly, the Yared notations in row 3 can be typed from “W” leaving the “w” to type Molla stress (“ [symbol] ”) and stretch (“˜”) marks along with the other stress, stretch and stress/stretch notations.

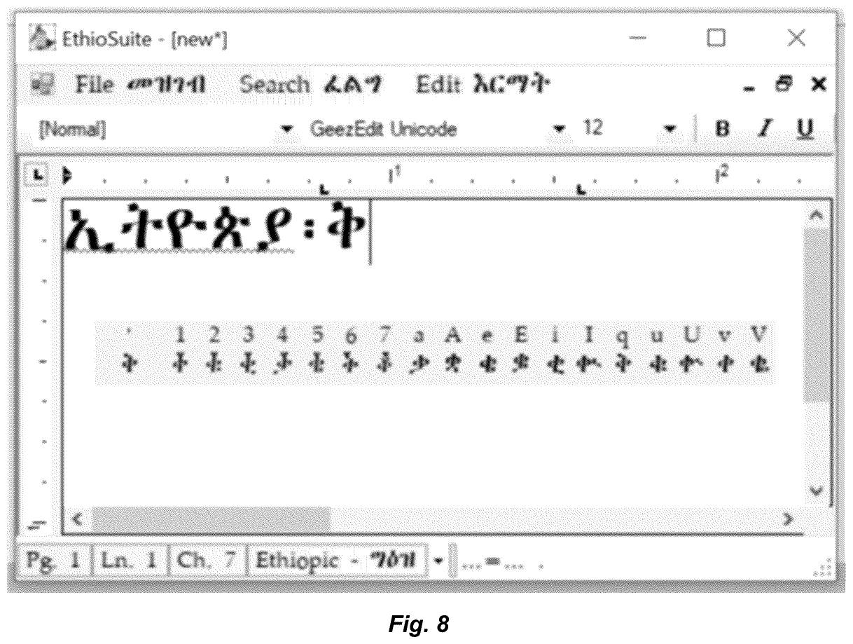

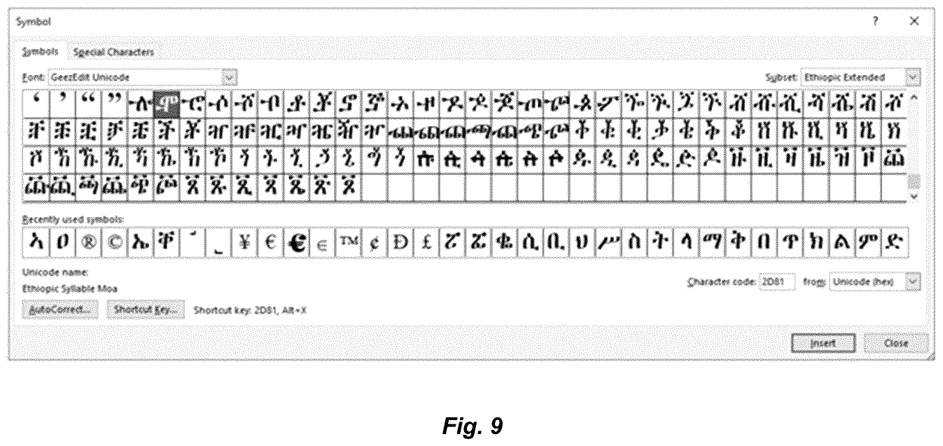

Row 4 is to type the novel Ethiopic symbols with “f” first keystroke as opposed to the previous backslash key (“\”) typing shown in row 844 of FIG. 8 described in U.S. Pat. No. 9,000,957. The six glyphs under reference 800 are “Ï”, “©”, “^{a}”, “ [symbol] ”, “ [symbol] ”, and “®”. These are Ethiopian sarcasm mark (848) ( [symbol] ), Ethiopian copyright symbol (855) ( [symbol] ), Ethiopian trademark symbol (856) ( [symbol] ), Ethiopian dollar (Birr/ [symbol] ) symbol (860), Ethiopian penny (Santim/ [symbol] ) symbol (864) and finally the character identified with reference number 868 is an Ethiopian registration mark ( [symbol] ). These are depicted in Row 5. The Ethiopic stress/stretch ( [symbol] ) keys can be typed from the “R” key with 1 through 6. The Molla stress/stretch marks from U.S. Pat. No. 9,000,957 can be typed from the “L” key with 9 and 0. These novel glyphs have not yet been included in Unicode and are thus dependent on the GeezEdit typefaces alone and should be used with this in mind. The novel keys include tonal marks as shown in FIG. 56 of U.S. Application No. 63/294,691 and rows 1 and 12 of FIG. 1.

Row 6 is for quotation marks. Similarly, “j1” is for “!” representing the typing of the Latin ten symbols in the row. Row 7 rendering with the “r” starts with the “minus” of the QWERTY layout is to go to the right and down to cover the ten symbols. Row 8 is for the shifted forms of the same symbols. Row 9 is to render the Ethiopic numerals from the “N” key.

Row 10 is to show the typing of the Ethiopic number “1” with “n1” while “x1” in row 11 is for number one. Row 12 is to render some Latin symbols with two keystrokes each.

Row 13 is to show the typing of “1” with the keyboard “1” key followed by the numeric pad “1” key. Row 14 is an example of typing “1” by double striking the number 1 key of the keyboard. Prerequisite for this step is assignment of the Ethiopic numerals to be typed from the numeric pad. Row 15 is to show that tabbing followed by a key can render the number one. It is also possible to use one of these rows such as “f” and “1” for the “ [symbol] ” series so that the Amharic is typed with no more than two keystrokes each.

Some of the above methods have also been shown. In the past only some of these glyphs were typed from the “123/#+=” while the “tab”, “123/#+=” and “!@#/−=” were not available before the invention. The blank spaces can be used for “#=+” and “#−+” to type more glyphs from a key such as “K”.

Additionally, the shift forms of the above are extra or reserved and can be used for other glyph typing. As a result, “x1” typing can render “1” from the numeric pad or the number key. The shift forms of the above are also available as options. For instance, the “sb” at 110 or row 10 column 0, is an optional “:” rendering method for Ethiopic wordspace ( [symbol] ).

With FIG. 1 as an example, it is clear that the current invention is another breakthrough because the “A” to “Z” keys are not consonants and vowels only but syllables just like the Ethiopic. Because every key is a vowel, there is no reason why we struggle with the “aeiou” only. The eighth Ethiopic vowel key has moved from the slash key to the number eight key and now to the period key. The vowel keys were always used as alphabets and vowels, though dedicated vowels are easier to work with.

As shown in FIG. 39 of U.S. Application No. 63/294,691, the positions of the glyph can be changed for good reason. An example is the default on the “S” key that is “ [symbol] ” instead of “ [symbol] ” and that is better as there are more Amharic words that use that character. The default was assigned to “ [symbol] ” because it comes ahead of the other one in the Ethiopic sorting order.

The typing and settling of an Ethiopic glyph with a single or shifted keystroke novelty has already been described in U.S. Pat. No. 10,133,362. It is possible to type and settle Ethiopic character sets such as those of Geez and Amharic with a single and shifted keystrokes too and that is another claim involving the abbreviated virtual and static keyboards for small character sets.

Another claim is modification of older methods shown in landscape smartphone Ethiopic as in FIG. 37 for use with the current novelty. The portrait could remain Amharic. The Amharic (FIG. 106) and Ethiopic (FIG. 107) vowels could be moved to the numbers or elsewhere as in FIG. 106-108 preferably with 11-key keyboard.

It is possible to move the glyphs around such that “q” types “ [symbol] v”. Qv could also type “ [symbol] ”, though that has been assigned to “ [symbol] ”. For instance, “tab Q” could type “ [symbol] ” increasing the typing of more glyphs or typing it also with “Q” only. As a result, the Tables as well as the Figures are examples and not limiting.

A method of typing Amharic with one and two keystrokes only in abbreviated computer keyboard with four rows of ten keys. It is also possible to use the current “A” to “Z” keys only plus the number row.

A new method of typing an Ethiopic glyph by touching the glyph on the screen with a finger is also disclosed herein. The Ethiopic characters show up on the screen when the Active Help Enabled as in EthioSuite and a glyph is typed with a key or mouse click. This applies to the shifted forms too. This results in the appearance of the glyphs along with the vowel forms and the corresponding glyphs line up in a box on the screen. Touching the Ethiopic glyph or the vowel assigned manually or with a mouse click types the corresponding glyph. This is ideal to teach the Ethiopic alphabet as the glyphs and vowels are touched. This is the beginning of speech and dictation for the alphabet. In some examples, the speech and dictation of the glyph can be played (e.g., via speakers or other audio devices associated with the keyboard, smartphone, and/or computer) when the user touches or clicks on the glyph. For example, the audio may play sounds associated with English “a” phenome or the Ethiopic “ [symbol] ” may be sounded out when the user clicks on or touches the glyph.

Method of not incorporating typing that interferes with previous or the following glyph rendering is unacceptable because of the need to add space and remove it. This includes toggling through glyphs. This does not mean that embodiments of the present disclosure do not support it.

It is possible to incorporating the previous methods of full keyboard incorporated with the current abbreviated methods. Thus “ [symbol] ” can also be typed with “[” key.

It should be understood that the invention's unique programing allows numerous typing methods and the fact that they were not mentioned here does not mean they were excluded; rather it is because there are many. For instance, toggling through the “E” key optionally generates “ [symbol] ”, “ [symbol] ” and “ [symbol] ”.

Methods of not incorporating typing that interferes with previous or the following glyph rendering are excluded for reasons. In one example typing a glyph followed by a “tab” would have generated a glyph but avoided because it could change the glyph typed ahead of the “tab” key. It is possible and claimed that settled glyphs can be generated by toggling through a key. For instance, an “ [symbol] ” type with an “a” keystroke can generate “ [symbol] ” on double striking it. This in turn can generate “ [symbol] ” with triple keystroke. While the “ [symbol] ” series can be typed with three keystrokes, more toggling and generating glyphs with four keystrokes is not recommended. This is also because even the “ [symbol] ” series can be generated with two keystrokes from the shifted vowel positions or with three keystrokes from the “X” key. Incorporation of those methods with current novelty as a new documentation claim is because plagiarists and copycats have been using toggling in their fake typing without settling the glyphs and thus without documentation for years. Assigning the “a” key to a different glyph does not mean the method is different. For instance, in a 10 by 4 abbreviated computer, smartphone and related gadgets, the non-alphabetic keys could be used as additional vowels instead of being limited to the “aeiou”.

Another novelty is generating a glyph by two or more different methods. An example is typing “1” with “tab 1” and “tab q” where “1” is a dead key while “q” is not. “1” can also be typed with “x1” and numeric pad “1” followed by Arabic numeral “1”. The numeric pad “1” followed by the Arabic numeral “1” types “1” because the Ethiopic numeral “1” is default on the numeric pad. There is thus no need to type a glyph with four keystrokes.

The settling of an Ethiopic glyph has continued to be a problem while Dr. Molla patented these methods and they have been incorporated in the current inventions. The claim now includes any method that allows settlement of the glyphs. For instance, the apostrophe settles the glyph typed ahead of it without showing it on the screen and without typing it. This programming method allows the appearance of the default when Active Help is Enabled to show all the choices.

Example features of the present disclosure include:

A significant novelty is assignment of any key for use as an Ethiopic vowel other than the Latin vowels. This is because Ethiopic has more vowels than Latin and there is no reason why Ethiopic should not use other keys as vowels. This applies to any layout where the vowels are numbers and other keys. This also applies to the Ethiopic for Oromo and related keyboarding.

A method of typing the more than 100 Ethiopic and Latin symbols and signs using the ten number keys as vowels.

Generating or typing the Ethiopic glyph by touching the corresponding Ethiopic glyph with a finger. With the “Active Help Enabled”, typing a glyph on the keyboard as usual or with a mouse result in the appearance of the glyphs along with the vowel forms and the corresponding glyphs line up in a box on the screen. Touching the Ethiopic vowel assigned as vowel or the Ethiopic glyph itself types the corresponding glyph. This also applies to shifted glyphs and other forms.

A method of typing the extended character glyphs such as “©” and “®” with two keystrokes each.

It is possible to type and settle Ethiopic character sets such as those of Geez and Amharic with a single and shifted keystrokes too and that is another claim involving the abbreviated virtual and static keyboards.

Modification of older methods shown in landscape smartphone Ethiopic as in FIG. 37 for use with the current novelty. The portrait could remain Amharic.

A method of using the Ethiopic writing system for relevant other world languages including Latin.

Method of not incorporating typing that interferes with previous or the following glyph rendering. This includes methods of documenting glyphs by toggling through them through glyphs. Incorporation of those methods with current novelty is a new claim.

A method of incorporating the previous methods of full keyboard incorporated with the current abbreviated methods. The keys outside the abbreviated computer and smartphone keys can be dropped or left to type English.

A method of generating zero to four glyphs from two-key input is claimed. For instance, striking the “tab” key does not generate any glyph while following it up with the “q” key generates “1”. A “tab” key held down while typing “q” generates “ [symbol] ” or “1”. A “q” key alone generates “ [symbol] ”. “Tab Q” can generate additional glyph such as “ [symbol] ” making more keystrokes available. “Tab K” could type “ [symbol] ” eliminating the use of the slash key to type it.

Any method that allows settlement of the glyphs is novel and claimed. The incorporation of rendering glyphs with apostrophe to show the defaults allows typing of the defaults by touching the letter on the screen.

Another novelty is using apps such as EthioSuite differently with or without the timeout as a publisher as well as a GeezEdit app host with or without the timeout. The apps can also mimic other keyboarding methods and use any Ethiopic font.

47. The use of the “tab” key is optional as it can be replaced by any of the other keys. For instance, the “ [symbol] ” can be moved to the “K” key and the “/” key can type Ethiopic period. A better claim and example are the option to utilize the “slash” key the way the “tab” is used so that it is not needed in typing. Assigning the “/” to eighth vowel and typing the Ethiopic period with the Latin period is possible and not novel.

What is claimed is:

1. A method, comprising:
receiving a first user input from a user;
rendering, in response to the first user input, a visual depiction of a set of keystrokes to a display;
receiving a second user input indicative of a selection of a first keystroke of the set of keystrokes; and
rendering, in response to the second user input, a first character associated with the first keystroke.

2. The method of claim 1, wherein the first user input is a second keystroke.

3. The method of claim 1, wherein the second user input is at least one of a mouse click and the user touching the display.

4. The method of claim 1, wherein an audio file associated with the first character is played when the second user input is received.

5. The method of claim 1, wherein the visual depiction further comprises a set of characters, and wherein each keystroke of the set of keystrokes corresponds to a character of the set of characters.
